(19) United States
(12) Patent Application Publication
(10) Pub. No.: US 2017/0220059 A1
(43) Pub. Date: Aug. 3, 2017

(54) REGULATOR CIRCUIT

(71) Applicant: KABUSHIKI KAISHA TOSHIBA, Tokyo (JP)

(72) Inventor: Hirokazu KADOWAKI, Fujisawa Kanagawa (JP)

(21) Appl. No.: 15/245,947

(22) Filed: Aug. 24, 2016

(30) Foreign Application Priority Data
Jan. 29, 2016 (JP) 2016-015849

(51) Int. Cl. G05F 1/575

(52) U.S. Cl. CPC G05F 1/575

(57) ABSTRACT

A regulator circuit includes a comparison unit outputting a voltage signal based on a difference between a reference voltage and a first voltage corresponding to an output voltage of the regulator circuit. An amplification unit is configured to amplify the voltage signal and output an amplified voltage signal. A supply unit is configured to supply an output current to a load, the output current being supplied according to the amplified voltage signal. A current source is connected between the amplification unit and the supply unit. The current source is configured to increase current flowing through the amplification unit when the output voltage drops below a predetermined level.

### CROSS-REFERENCE TO RELATED APPLICATION

This application is based upon and claims the benefit of priority from Japanese Patent Application No. 2016-015849, filed on Jan. 29, 2016, the entire contents of which are incorporated herein by reference.

### FIELD

Embodiments described herein relate generally to a regulator circuit.

### BACKGROUND

Portable electronic devices require, in general, reduced current consumption. Certain portable electronic devices include a low dropout (LDO) linear regulator circuit which consumes current. It would be desirable to reduce the current consumption of these LDO linear regulator circuits. However, when the current consumption of a linear regulator circuit is reduced, it may not be possible to supply a sufficient load current when the operation state of the load drawing current is rapidly changed over short time periods. Accordingly, when the current consumption of the linear regulator circuit is reduced, the linear regulator circuit cannot cope with rapid changes in an output voltage over short time periods.

### DESCRIPTION OF THE DRAWINGS

FIG. 1 is a diagram illustrating an example of a configuration of a regulator circuit according to a first embodiment.

FIG. 2 is a diagram illustrating an example of a configuration of a regulator circuit according to a second embodiment.

FIG. 3 is a diagram illustrating an example of a configuration of the regulator circuit according to a modification of the first embodiment.

FIG. 4 is a diagram illustrating an example of a configuration of the regulator circuit according to a modification of the second embodiment.

### DETAILED DESCRIPTION

According to an embodiment, a regulator circuit is provided.

In general, according to one embodiment, a regulator circuit includes a comparison unit outputting a voltage signal based on a difference between a reference voltage and a first voltage corresponding to an output voltage of the regulator circuit. An amplification unit is configured to amplify the voltage signal and output an amplified voltage signal. A supply unit is configured to supply an output current to a load, the output current being supplied according to the amplified voltage signal. A current source is provided between the amplification unit and the supply unit. The current source is configured to increase current flowing through the amplification unit when the output voltage drops below a predetermined level.

Hereinafter, example embodiments will be described with reference to the accompanying drawings. The present disclosure is not limited to the example embodiments.

### First Embodiment

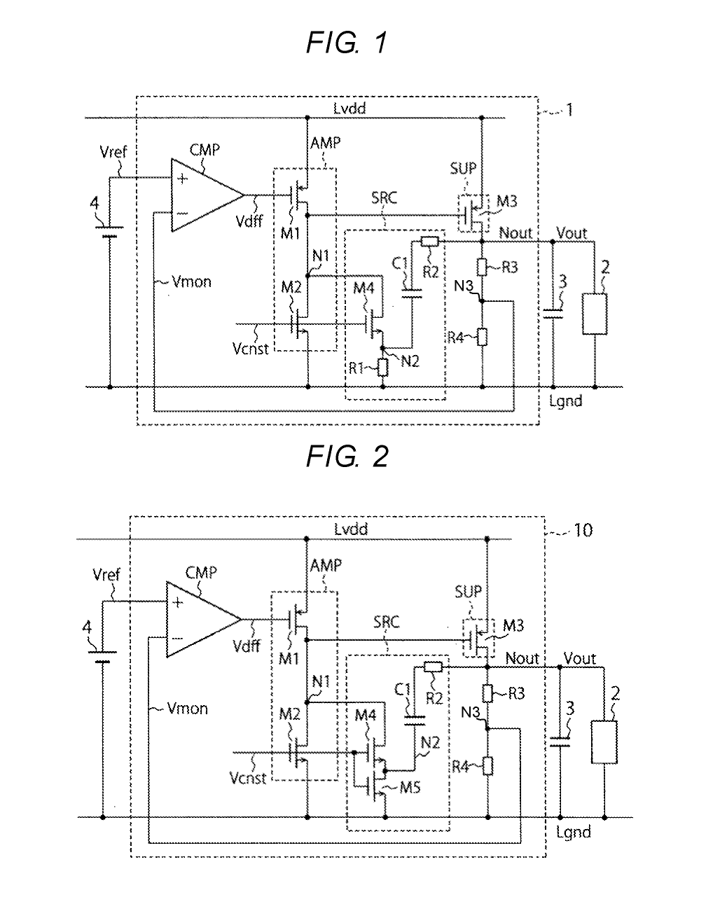

FIG. 1 is a diagram illustrating an example of a linear regulator circuit 1 (hereinafter, referred to as a regulator circuit 1) according to a first embodiment. The regulator circuit 1 includes an output node Nout, which is connectable to a load 2. The regulator circuit 1 applies an output voltage Vout to the load 2 from the output node Nout. The output node Nout may be, for example, a pad or a terminal. The load 2 is, for example, a portable electronic apparatus, or a portion thereof, which consumes relatively small amounts of power when in a stopped state (OFF state or stand-by state), but consumes relatively high amounts of power during a start-up state when transitioning from the stopped state to a stable (normal) operating state. When the load 2 is changed from a stopped state into the start-up state, a large amount of power is rapidly required. For example, it is preferable that a camera function of a smart phone starts up in a short time, thus it is necessary for the regulator circuit 1 to increase the current supplied from the output node Nout in a short time when the camera function starts up. The nearly instantaneous increase in supplied current causes a large decrease in output voltage Vout. Hence, for the regulator circuit 1 to prevent an excessive decrease in the output voltage Vout during startup of load 2, it is preferable to quickly follow up a change in the output voltage Vout. An output capacitor Co is provided to supply a current to load 2 when the output voltage Vout decreases substantially. The output capacitor Co is connected between the output node Nout and a ground potential (e.g., a ground line Lgnd). However, the output capacitor Co alone may not be sufficient to prevent the output voltage Vout from decreasing when a large amount of power is rapidly required.

Accordingly, the regulator circuit 1 connected to the load 2 has the following configuration. The regulator circuit 1 includes a comparison unit CMP, an amplification unit (amplifier) AMP, a supply unit SUP, an auxiliary current source SRC, and voltage dividing resistance elements (resistors) R3 and R4.

The comparison unit CMP may be, for example, a differential amplification circuit (operational amplifier). A non-inverting input of the comparison unit CMP is connected to a power supply 4 which generates a reference voltage Vref. The power supply 4 supplies reference voltage Vref to the regulator circuit 1 through a power supply pad (not specifically illustrated). Alternatively, the power supply 4 may be incorporated in a chip of the regulator circuit 1 or otherwise integrated. An inverting input of the comparison unit CMP is connected between the voltage dividing resistance elements R3 and R4. The voltage dividing resistance elements R3 and R4 are connected in series between the output node Nout and a second power supply line Lgnd and divide the output voltage Vout to generate a monitor voltage (first voltage, feedback voltage) Vmon, which is approximately proportional to the output voltage Vout. The comparison unit CMP receives the monitor voltage Vmon and the reference voltage Vref, and outputs a differential voltage Vdff based on a difference between the monitor voltage Vmon and the reference voltage Vref. The comparison unit CMP may output a voltage difference between the monitor voltage Vmon and the reference voltage Vref as the differential voltage Vdff, or may output the voltage difference which has been amplified as the differential voltage Vdff.

The amplification unit AMP includes a first transistor M1 and a second transistor M2, which are connected in series between the first power supply line Lvdd and the second power supply line Vgnd. The first power supply line Lvdd is a wire which is connectable to a voltage source which supplies, for example, a high level voltage VDD. The second power supply line Lgnd is a wire which is connectable to a voltage source which supplies, for example, a low level voltage (for example, a ground potential).

The first transistor M1 is, for example, a p-channel metal insulator semiconductor field effect transistor (MISFET). A gate of the first transistor M1 is connected to an output node of the comparison unit CMP, and receives the differential voltage Vdff. A source of the first transistor M1 is connected to the first power supply line Lvdd, and a drain of the first transistor M1 is connected to a first node N1.

The second transistor M2 is, for example, an n-channel MISFET. Agate of the second transistor M2 receives a constant voltage Vcnst. A drain of the second transistor M2 is connected to the first node N1, and is thus connected to the drain of the first transistor M1 through the first node N1. A source of the second transistor M2 is connected to the second power supply line Lgnd.

The first transistor M1 controls electrical resistance between the first node N1 and the first power supply line Lvdd, based on the differential voltage Vdff, and changes a current accordingly. The second transistor M2 receives constant voltage Vcnst and supplies (or draws) a constant current to (from) the first transistor M1. That is, the second transistor M2 functions as a constant current source (or sink) to change the current flowing through amplification unit AMP from what it would otherwise be in the absence of the second transistor M2. For example, when the monitor voltage Vmon is lower than the reference voltage Vref, the differential voltage Vdff becomes a positive voltage, whereby the first transistor M1 is turned off. Hence, a current flowing from the first power supply line Lvdd to the first node N1 decreases, and a constant current flows through the second transistor M2 from the first node N1. Therefore, a voltage of the first node N1 decreases. At this time, the auxiliary current source SRC also supplies a current, but a function of the auxiliary current source SRC will be further described below. When the monitor voltage Vmon is higher than the reference voltage Vref, the differential voltage Vdff becomes a negative voltage, whereby the current flowing through the first transistor M1 increases. Hence, a current flowing from the first power supply line Lvdd to the first node N1 increases. At this time, a constant current still continuously flows through the second transistor M2, but as a current from the first power supply line Lvdd is much larger than the constant current flowing through the second transistor M2, a voltage of the first node N1 increases. Accordingly, the differential voltage Vdff is amplified to be between the high level voltage VDD and the low level voltage GND at the first node N1, and this first node N1 voltage is provided to the supply unit SUP.

The supply unit SUP includes a third transistor M3. The third transistor M3 is, for example, a p-type MISFET. A gate of the third transistor M3 is connected to the first node N1, and receives the voltage (first node N1 voltage) which has been amplified by the amplification unit AMP. A source of the third transistor M3 is connected to the first power supply line Lvdd. A drain of the third transistor M3 is connected to the output node Nout. The drain of the third transistor M3 is connected to the second power supply line Lgnd through the voltage dividing resistance elements R3 and R4. That is, a voltage from the drain of the third transistor M3 is applied to the load 2 as the output voltage Vout.

The third transistor M3 controls electrical resistance between the output node Nout and the first power supply line Lvdd, based on a voltage of the first node N1, and thus changes an output current accordingly. Thus, the third transistor M3 supplies a current to the load 2 according to the output of the amplification unit AMP (i.e., voltage at the first node N1). For example, when the monitor voltage Vmon is lower than the reference voltage Vref, the voltage of the first node N1 approaches the low level voltage GND, and a current flowing through the third transistor M3 increases. Hence, a current flowing from the first power supply line Lvdd to the output node Nout increases. Accordingly, increased power is supplied to the load 2. When the monitor voltage Vmon is higher than the reference voltage Vref, the voltage of the first node N1 approaches the high level voltage VDD, and a current flowing through the third transistor M3 decreases. Hence, a current flowing from the first power supply line Lvdd to the output node Nout decreases, and a voltage of the output node Nout approaches a voltage of the second power supply line Lgnd through the voltage dividing resistance elements R3 and R4. Accordingly, the power which is supplied to the load 2 decreases. In this manner, the regulator circuit 1 feeds back the output voltage Vout as the monitor voltage Vmon, supplies a current to the output node Nout when the output voltage Vout is relatively low, and stops supplying the current to the output node Nout when the output voltage Vout is relatively high. Accordingly, the regulator circuit 1 operates so as to maintain the output voltage Vout as an approximately constant voltage.

The auxiliary current source SRC includes a fourth transistor M4, a first resistance element R1, a first capacitor C1, and a second resistance element R2. The fourth transistor M4 is, for example, an n-type MISFET. A gate of the fourth transistor M4 receives the constant voltage Vcnst in common with the gate of the second transistor M2. A drain of the fourth transistor M4 is connected to the first node N1, and a source of the fourth transistor M4 is connected to a second node N2. The first resistance element R1 is connected between the second node N2 and the second power supply line Lgnd. That is, the fourth transistor M4 and the first resistance element R1 are connected in series between the first node N1 and the second power supply line Lgnd. The first capacitor C1 is electrically connected between the second node N2 and the output node Nout, and the second resistance element R2 is electrically connected between the first capacitor C1 and the output node Nout. That is, the first capacitor C1 and the second resistance element R2 are connected in series between the second node N2 and the output node Nout. The second resistance element R2 is provided to reduce the voltage applied to the first capacitor C1 when the first capacitor C1 is, for example, a MOS capacitor subject to breakdown at high voltages. Meanwhile, in this context, “connection” includes not only a direct connection but also any electrical connection, such that other elements, wires, or the like may be interposed between the elements which are referred to as connected to each other.

Agate of the fourth transistor M4 receives the constant voltage Vcnst like the gate of the second transistor M2. However, a source of the fourth transistor M4 is connected to the second power supply line Lgnd through the first resistance element R1, whereby a source voltage becomes a higher voltage than the low level voltage due to first resistance element R1, at least when the output voltage Vout does not drop a voltage of the second node N2. That is, the source voltage of the fourth transistor M4 can be set to be higher than a source voltage of the second transistor M2. Accordingly, the fourth transistor M4 receives the constant voltage Vcnst in common with the second transistor M2 and performs control, but while the second transistor M2 is approximately turned on by constant voltage Vcnst, the fourth transistor M4 is still maintained in an off state. For example, when the load 2 is in a state (normal operation state) of normally starting up, the regulator circuit 1 stabilizes the output voltage Vout to a certain voltage and the monitor voltage Vmon that is fed back approaches the reference voltage Vref. In this case, when the monitor voltage Vmon is approximately equal to the reference voltage Vref, the differential voltage Vdff has its normal operating value or differs from its normal operating value by only a small amount. A voltage of the first node N1 is determined by the differential voltage Vdff and the current flowing through the second transistor M2, and the conductance state of the third transistor M3 is determined by the voltage of the first node N1. The output voltage Vout is maintained by operation of the third transistor M3. When the load 2 is in a normal operation state, the source voltage of the fourth transistor M4 is higher than that of the second transistor M2, and the fourth transistor M4 thus is maintained in a substantially non-conducting state. Accordingly, when the load 2 is in the normal operation state, although current from the first node N1 flows through the second transistor M2, the current from the first node N1 does not significantly flow through the fourth transistor M4.

Meanwhile, when the load 2 is changed from a stopped state into a start-up state (which can be considered a transition state between the stopped state and a normal operation state of the device), the output voltage Vout can decrease rapidly and significantly as described above. In this case, the decreased output voltage Vout is transferred to the second node N2 though the second resistance element R2 and the first capacitor C1, and this works to significantly decrease the source voltage of the fourth transistor M4. Accordingly, immediately after the output voltage Vout rapidly decreases, the fourth transistor M4 is substantially turned on (placed in a conductive state) in a time that is shorter than a time required for the feedback-control the monitor voltage Vmon to operate so as to adjust the conductance of the first transistor M1. A current flows through the second transistor M2 and the fourth transistor M4 from the first node N1, and thus, a current flowing through the amplification unit AMP is increased, and a voltage (gate voltage of the third transistor M3) of the first node N1 can decrease in a short time in this manner.

The auxiliary current source SRC is connected between the amplification unit AMP and the supply unit SUP, and the current flowing through the amplification unit AMP increases based on the change in the output voltage Vout, as will be described below. The second resistance element R2 is not necessarily provided in all embodiments of the auxiliary current source SRC.

Subsequently, an operation of the regulator circuit 1 will be described.

Case where Load 2 is in Normal Operation State

When the load 2 is in a normal operation state, the output voltage Vout is relatively stable, and the monitor voltage Vmon is stable and is at a level in the vicinity of the reference voltage Vref level. At this time, as described above, the fourth transistor M4 is substantially in a turn-off state, and the auxiliary current source SRC hardly affects a current from the amplification unit AMP. Meanwhile, the differential voltage Vdff is near a certain normal operating value. Accordingly, the first transistor M1 cycles between a turn-on state and turn-off state, so that the monitor voltage Vmon is maintained to approximately equal to the reference voltage Vref. Alternatively, the first transistor may be controlled to be within a linear operation region between the active region and the subthreshold region. The current from the first node N1 flows through the second transistor M2, and thus, the voltage of the first node N1 depends upon the conductance state of the first transistor M1. The third transistor M3 has a conductance state controlled according to the voltage of the first node N1, and adjusts the output voltage Vout. In this manner, when the load 2 is in the normal operation state, the regulator circuit 1 feeds back the monitor voltage Vmon (corresponding to the output voltage Vout) to the comparison unit CMP, and thus controls the output voltage Vout so that the monitor voltage Vmon will be equal to the reference voltage Vref. In the normal operation state, the output voltage Vout does not change rapidly or significantly, and thus, little current flows through the auxiliary current source SRC.

Case where Load 2 is Changed from Stopped State to Start-Up State

When the load 2 is in the stopped state, current consumption of the load 2 is significantly reduced. However, even in this case, the regulator circuit 1 adjusts the output voltage Vout so that the monitor voltage Vmon will be equal to the reference voltage Vref. At this time, little current flows through the auxiliary current source SRC in much the same manner as during the normal operation state.

When the load 2 is changed from the stopped state to the start-up state, current consumption of the load 2 is rapidly increased. In this case, the output voltage Vout decreases rapidly and significantly. This decreased output voltage Vout is transferred to the second node N2 through the second resistance element R2 and the first capacitor C1, and consequently a source voltage of the fourth transistor M4 significantly decreases. Accordingly, as described above, immediately after the output voltage Vout rapidly decreases, the fourth transistor M4 is in a conducting state. The source of the fourth transistor M4 receives the output voltage Vout in a relatively direct manner from the output node Nout through the second resistance element R2 and the first capacitor C1, and thus, the fourth transistor M4 operates more quickly than elements in the feedback control (e.g., comparison unit CMP and first transistor M1) of the regulator circuit 1. Hence, the fourth transistor M4 operates to quickly decrease the voltage of the first node N1, and controls the third transistor M3 to increase the output voltage Vout in a short time after the rapid decrease in the output voltage Vout when the load 2 was started up from a stopped state. Accordingly, the third transistor M3 can quickly recover the output voltage Vout.

Thereafter, the load 2 maintains the its start-up state, and the output voltage Vout becomes relatively stabilized allowing the monitor voltage Vmon to be stabilized in the vicinity of the reference voltage Vref. Accordingly, the load 2 can be considered to have entered into its normal operation state.

In this manner, according to the present embodiment, the auxiliary current source SRC increases the current flowing through the amplification unit AMP, based on the output voltage Vout, when the load 2 is changed from the stopped state. Accordingly, the regulator circuit 1 can quickly recover the output voltage Vout to cope with a significant decrease in output voltage Vout, even though current drive capability of the second transistor M2 is relatively small.

Little current from the amplification unit AMP flows through the auxiliary current source SRC, when the load 2 is in the normal operation state. Hence, after the load 2 is changed from the stopped state to the start-up state and enters its normal operation state the little current flows through the fourth transistor M4 although some current still flows through the second transistor M2 of the amplification unit AMP in the regulator circuit 1. Accordingly, it is possible to substantially reduce the current drive capability of the second transistor M2 and to maintain the overall current consumption of the regulator circuit 1 to be a small amount (for example, equal to or less than 1 μA).

The regulator circuit 1 according to the present embodiment includes a feedback circuit (the comparison unit CMP, the amplification unit AMP, and the supply unit SUP) which controls the output voltage Vout by feeding back the monitor voltage Vmon corresponding to the output voltage Vout. Accordingly, when the load 2 is in the normal operation state, the regulator circuit 1 can be stabilized by controlling the output voltage Vout such that the monitor voltage Vmon becomes equal to the reference voltage Vref.

When the auxiliary current source SRC is not provided, the feedback function may still be effectively performed using the comparison unit CMP and the first transistor M1 under stable operating conditions, but when the current consumed by the load 2 rapidly changes, transient response characteristics of the regulator circuit are comparably degraded. In this case, it is possible to improve the transient response characteristics of the output voltage Vout by increasing a current flowing through a regulator circuit. However, it is not preferable to increase a current consumed in the regulator circuit in devices which require low power consumption, such as a portable electronic apparatus. Hence, it is difficult to satisfy both the low current consumption requirements and the need for improved transient response characteristics when auxiliary current source SRC or the like is not provided in the regulator circuit.

In contrast to this, the regulator circuit 1 according to the present embodiment provides the auxiliary current source SRC. As such, current flowing through the amplification unit AMP does not substantially increase when the load 2 is in the normal operation state, and yet the current flowing through the amplification unit AMP increases when the load 2 is changed from a stopped state to a start-up state. Accordingly, the regulator circuit 1 can limit power consumption while improving the transient response characteristics of the output voltage Vout provided by the regulator circuit 1.

### Second Embodiment

FIG. 2 is a diagram illustrating an example of a configuration of a regulator circuit 10 according to a second embodiment. The second embodiment is different from the first embodiment in that the second embodiment includes a fifth transistor M5 which functions as the first resistance element (compare element R1 in FIG. 1). Other aspects of the second embodiment may otherwise be the same as the first embodiment.

The fifth transistor M5 is, for example, an n-type MISFET. A gate of the fifth transistor M5 receives a constant voltage in common with the gate of the fourth transistor M4. A drain of the fifth transistor M5 is connected to the second node N2, and a source of the fifth transistor M5 is connected to the second power supply line Lgnd.

When load 2 is in the normal operation state, the fifth transistor M5 may be in conducting state. In this case, the fifth transistor M5 is designed so that ON resistance of the fifth transistor M5 (when constant voltage Vcnst is applied to the gate of fifth transistor) is approximately equal to resistance of the second resistance element R2 according to the first embodiment. The fourth transistor M4 is non-conducting state when the load 2 is in the normal operation state. The source of the fourth transistor M4 is connected to the output node Nout through the first capacitor C1 and the second resistance element R2. Hence, the fourth transistor M4 increases a current flowing through the amplification unit AMP when the load 2 is changed from the stopped state to start-up state. Hence, the regulator circuit 10 can perform substantially the same operation as the regulator circuit 1. Accordingly, the second embodiment can obtain the same effects as the first embodiment.

### Modification Example 1

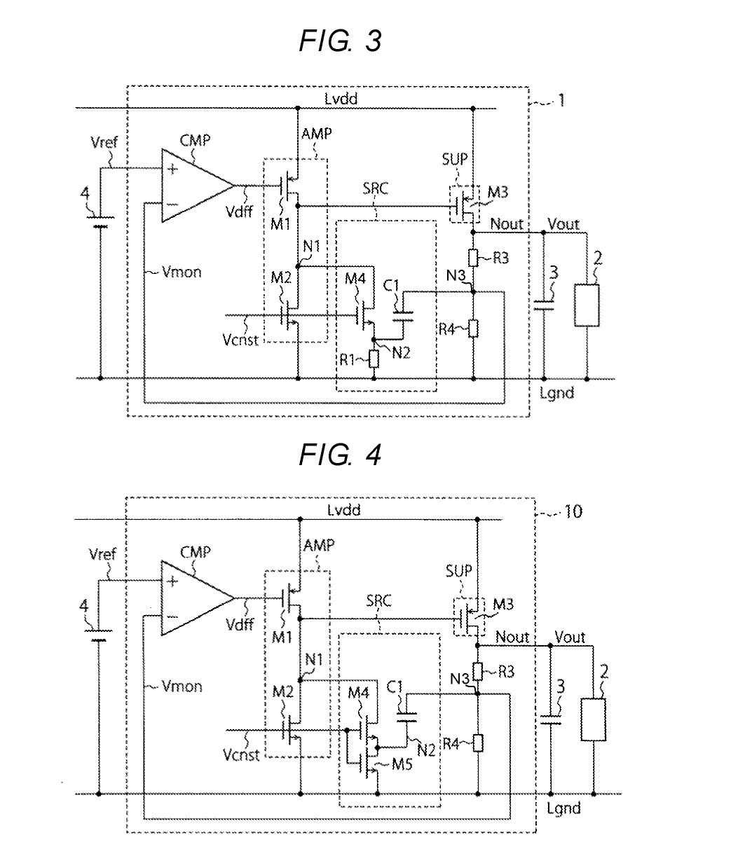

FIG. 3 is a diagram illustrating an example of the regulator circuit 1 according to a modification example 1. In the present modification example, the first capacitor C1 is not connected between the output node Nout and the second node N2, but rather is connected between a third node N3 and the second node N2. The third node N3 is a node connected between the resistance element R3 and the resistance element R4. In the present modification example, the resistance element R3 may be said to have both a voltage division function (dividing Vout with R4 to provide Vmon) and the function of the second resistance element R2 depicted as a separate element in FIG. 1. That is, in this modification example, resistance elements R2 and R3 are in effect combined into single element R3.

Accordingly, the auxiliary current source SRC increases a current flowing through the amplification unit AMP by the monitor voltage Vmon according to the output voltage Vout. The monitor voltage Vmon is obtained by dividing the output voltage Vout using the voltage dividing resistance elements R3 and R4, and thus, the monitor voltage Vmon corresponds to the output voltage Vout. Hence, the regulator circuit 1 according to the present modification example can also increase the current flowing through the amplification unit AMP, based on the output voltage Vout, when the load 2 is changed from the stop state to the start-up state. That is, the present modification example can operate in the same manner as the first embodiment.

### Modification Example 2

FIG. 4 is a diagram illustrating an example of a configuration of the regulator circuit 10 according to a modification example 2 of the second embodiment. In the modification example 2 the conceptual aspects of modification example 1 are applied to the second embodiment. Thus, in modification example 2, the first capacitor C1 is connected between the third node N3 and the second node N2 rather than between output node Nout and second node N2 with a resistance element R2 between the first capacitor and the output node Nout. That is, in effect functions of second resistance element R2 and third resistance element R3 are, in effect, combined in the third resistance element R3. Accordingly, the auxiliary current source SRC increases the current flowing through the amplification unit AMP by the monitor voltage Vmon according to the output voltage Vout. Hence, the regulator circuit 10 according to the modification example 2 can also increase the current flowing through the amplification unit AMP, based on the output voltage Vout, when the load 2 is changed from the stopped state to the start-up state. That is, the modification example 2 can operate in the same manner as the second embodiment.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A regulator circuit, comprising:
a comparison unit that outputs a voltage signal based on a difference between a reference voltage and a first voltage corresponding to an output voltage of the regulator circuit;
an amplification unit configured to amplify the voltage signal and output an amplified voltage signal;
a supply unit configured to supply an output current to a load, the output current supplied according to the amplified voltage signal; and
a current source provided between the amplification unit and the supply unit, and configured to increase current flowing through the amplification unit when the output voltage drops below a predetermined level.

2. The regulator circuit according to claim 1, wherein
the amplification unit includes first and second transistors connected in series between a first power supply line and a second power supply line,
a gate of the first transistor is connected to an output node of the comparison unit,
a gate of the second transistor receives a constant voltage,
the supply unit includes a third transistor connected between the first power supply line and the second power supply line, and
a gate of the third transistor is connected to a first node that is between the first transistor and the second transistor.

3. The regulator circuit according to claim 2, wherein the current source includes:
a fourth transistor and a first resistance element connected in series between the first node and the second power supply line; and
a first capacitor connected between an output node of the supply unit and a second node that is between the fourth transistor and the first resistance element.

4. The regulator circuit according to claim 3, wherein a gate of the fourth transistor receives the constant voltage in common with the gate of the third transistor.

5. The regulator circuit according to claim 3, further comprising:
a second resistance element connected between the first capacitor and the output node of the supply unit.

6. The regulator circuit according to claim 5, wherein the first resistance element is a fifth transistor having a gate that receives the constant voltage in common with the gate of the fourth transistor.

7. The regulator circuit according to claim 5, wherein
the comparison unit receives the first voltage from a third node that is between a third resistance element and a fourth resistance element that are connected in series between the output node and the second power line, and
the first capacitor is connected to the output node through the second resistance element.

8. The regulator circuit according to claim 3, wherein the first resistance element is a fifth transistor having a gate that receives the constant voltage in common with the gate of the fourth transistor.

9. The regulator circuit according to claim 3, wherein
the comparison unit receives the first voltage from a third node that is between a third resistance element and a fourth resistance element that are connected in series between the output node and the second power line, and
the first capacitor is connected to the output node through the third resistance element.

10. A regulator circuit, comprising:
a comparison unit configured to compare a reference voltage and a first voltage corresponding to an output voltage at an output node of the regulator circuit;
a first transistor having a gate connected to an output node of the comparison unit, a source connected to a first power supply line having a first potential, and a drain connected to a first node;
a second transistor having a gate connected to a constant voltage line, a drain connected to the first node, and a source connected to a second power supply line having a second potential;
a third transistor having a gate connected to the first node, a source connected to the first power supply line, and a drain connected to the output node;
a fourth transistor having a gate connected to the constant voltage line, a drain connected to the first node, and a source which is connected to a second node;
a first resistance element connected between the second node and the second power supply line; and
a first capacitor connected between the second node and the output node.

11. The regulator circuit according to claim 10, wherein
the first transistor is a p-type metal-insulator-semiconductor field effect transistor (MISFET);
the second transistor is a n-type MISFET;
the third transistor is a p-type MISFET; and
the fourth transistor is an n-type MISFET.

12. The regulator circuit according to claim 10, wherein the first resistance element is a fifth transistor having a gate connected to the gate of the fourth transistor.

13. The regulator circuit according to claim 10, wherein
the first voltage is obtained from a third node between a third resistance element and a fourth resistance element that are connected in series between the output node of the regulator circuit and the second power supply line, and the first capacitor is connected to the output node of the regulator circuit through the third node.

14. The regulator circuit according to claim 13, wherein the first resistance element is a fifth transistor having a gate connected to the gate of the fourth transistor.

15. The regulator circuit according to claim 10, further comprising:
a second resistance element connected between the first capacitor and the output node of the regulator circuit;
a third resistance element and a fourth resistance element connected in series between the output node of the regulator circuit and the second power supply line, wherein the first voltage is supplied to the comparison unit from a third node between the third and fourth resistance elements.

16. An electronic device, comprising:
a power supply supplying a first potential to a first power supply line and a second potential to a second power supply line; and
a regulator circuit connected to the first and second power supply lines and outputting an output voltage at a first output node that is connectable to a load circuit, the regulator circuit including:
a comparison unit configured to compare a reference voltage and a first voltage corresponding to the output voltage at the first output node;
a first p-channel field effect transistor having a gate connected to an output node of the comparison unit, a source connected to the first power supply line, and a drain connected to a first node;
a second n-channel field effect transistor having a gate connected to a constant voltage line, a drain connected to the first node, and a source connected to the second power supply line;
a third p-channel field effect transistor having a gate connected to the first node, a source connected to the first power supply line, and a drain connected to the first output node;
a fourth n-channel field effect transistor having agate connected to the constant voltage line, a drain connected to the first node, and a source which is connected to a second node;
a first resistance element connected between the second node and the second power supply line; and
a first capacitor connected between the second node and the first output node.

17. The electronic device according to claim 16, further comprising:
a second resistance element connected between the first capacitor and the first output node;
a third resistance element and a fourth resistance element connected in series between the first output node and the second power supply line, wherein the first voltage is supplied to the comparison unit from a third node between the third and fourth resistance elements.

18. The electronic device according to claim 17, wherein the first resistance element is a n-channel field effect transistor having a gate connected to the gate of the fourth n-channel transistor, a drain connected to the second node, and a source connected to the second power supply line.

19. The electronic device according to claim 16, further comprising:
a third resistance element and a fourth resistance element connected in series between the first output node and the second power supply line, wherein
the first voltage is supplied to the comparison unit from a third node between the third and fourth resistance elements, and
the first capacitor is connected to the first output node through the third node.

20. The electronic device according to claim 19, wherein the first resistance element is a n-channel field effect transistor having a gate connected to the gate of the fourth n-channel transistor, a drain connected to the second node, and a source connected to the second power supply line.
